(19) United States
(12) Patent Application Publication
(10) Pub. No.: US 2010/0015567 A1
(43) Pub. Date: Jan. 21, 2010

(54) Dental Hygiene Tool

(76) Inventors: Jean-Jacques Elbaz, Beverly Hills, CA (US); Roger J. Malcolm, San Clemente, CA (US)

Correspondence Address: CHARMASSON, BUCHACA & LEACH, LLP, 2635 Camino Del Rio South, Suite 102, SAN DIEGO, CA, 92108, US

(21) Appl. No.: 12/176,330

(22) Filed: Jul. 18, 2008

(51) Int. Cl. A61C 15/00

(52) U.S. Cl. 433/89

(57) ABSTRACT

A dental hygiene tool particularly adapted for cleaning and treating dental spaces, surfaces and other areas including interproximal surfaces, orthodontic appliances, bridgework, crowns, surgical sites, implants and periodontal pockets and for gently massaging and compressing gingival tissues and to help reduce inflamation and pocket depth, in a single device. The tool comprises a conical, hollow, compressible and expansive tip made of elastomeric material and having a pointed end dimensioned to penetrate interproximal spaces. Rows of pointed spicules of the same material project radially from the outer surface of the tip in progressively diminishing sizes from the base of the conical tip to its apex. The tip is mounted to the distal end of a handle upon a reinforcing prong to limit the collapsibility of the tip, and provide better ability to guide the tip to a desired location. The handle can be made hollow and be connected to a pulsating source of fluid causing the tip to alternately inflate and retract providing a vibrating massage to the contacted areas. Small bores in the tip or spouts on the distal end of the handle can squirt a lubricating, cleansing and/or therapeutic agent loaded liquid.

### FIELD OF THE INVENTION

The instant invention relates to dentistry and dental hygiene instruments, and more specifically to dental area cleaning, massaging, treatment and therapeutic agent injecting devices.

### BACKGROUND

The prior art is replete with disclosures of various dental hygiene tools for cleaning and treating teeth, gums and other dental areas. Among the latest disclosures are: U.S. Pat. No. 7,232,310, Hen et al.; US Publication No. 2003/4224320, Kandelman et al.; and US Publication No. 2006/0174910, Coopersmith. Each of the above three disclosures are incorporated herein by this reference.

The instant embodiments result from attempts to devise a more effective implement that can help penetrate, clean, massage, compress and therapeutically treat dental areas by way of friction, pressure, and in some embodiments including vibration and irrigation, using a compact and inexpensive tool.

### SUMMARY

The instant invention provides a dental hygiene tool for professional and home use that is particularly adapted to help massage and clean dental areas, surfaces and spaces, including teeth, periodontal areas, orthodontic appliances, post-operative surgical sites, restorative bridge work, and further adapted to provide compaction and to reduce scratching of sensitive dental implants.

In some embodiments the tool comprises a small, resiliently collapsible, conical tip having asperities in the form of spicules made integrally with and of the same elastomeric material as the tip body. In some embodiments the tip is hollow and is mounted at the distal end of a handle having a reinforcing prong loosely engaging an internal cavity of the tip. In some embodiments portions of the tip resiliently collapse under the forces of contact with the dental areas until those portions contact the reinforcing prong, thereby preventing further collapse, allowing the tip portions to quickly expand when forces are reduced. In some embodiments the tool is provided with small bores between the spicules, and on other parts of the tool, to wash the spicules and irrigate or deliver therapeutic agents to the cleaned areas. In some embodiments the tools is adapted to provide motion to the tip such as vibration, oscillation, reciprocating axial penetration, reciprocating turning or continuous single direction rotation, or combination of such movements. In some embodiments the handle is tubular and is connected to a pulsating pump. In some embodiments the pump modulates a fluid, either gas or liquid, and generates spurts of the pressurized fluid causing the tip to rapidly and alternately expand and contract in order to create frictional vibrations to better clean or massage the dental areas. In some embodiments the pressurized fluid flows through a turbine structure to cause rotation of the tip.

In some embodiments there is provided a dental hygiene tool which comprises: a hollow and resiliently collapsible tip having an external surface and an internal surface defining an internal cavity; a mounting structure associated with said tool; said mounting structure comprising a substantially rigid reinforcing member; and, said tip being mounted to said mounting structure; and said reinforcing member loosely engaging said cavity.

In some embodiments said tip is dimensioned to penetrate interproximal spaces in an animal; and, wherein said tip comprises a base, a distal end and a wall therebetween. In some embodiments said wall is substantially conical. In some embodiments said tip comprises an elastomeric material. In some embodiments said tip is sized and shaped to provide an effective durometer of between about 10 A and about 60 A on the ASTM durometer scale.

In some embodiments there is provided a tool which comprises a number of said tips each having a different effective durometer than the others of said tips. In some embodiments said tips are color coded.

In some embodiments said tip has a surface color corresponding to said effective durometer.

In some embodiments said reinforcing member is sized and shaped to provide a reducible gap between an outer surface of said reinforcing member and said internal surface of said tip. In some embodiments said gap surrounds said reinforcing member when said tip is in an expanded state.

In some embodiments said reinforcing member comprises a distal extremity spaced an axial distance apart from an inner surface of said tip.

In some embodiments said reinforcing member comprises a distal extremity in contact with said tip and thereby said reinforcing member acts as a guide for said tool.

In some embodiments said reinforcing member is sized and shaped to have an elongated dimension extending along an elongation axis and wherein said reinforcing member has a cross-section taken perpendicular to said axis, wherein said cross section has a first shape. In some embodiments said first shape is selected from the group consisting of: circles, ellipses, triangles, quadrangles, polygons, shapes having concave portions, and shapes having parabolic portions.

In some embodiments said tip comprises a plurality of asperities joined integrally with, and projecting radially from said external surface. In some embodiments said asperities comprise a number of spicules having progressively diminishing sizes from said base to said distal end. In some embodiments said asperities comprise: a first group of spicules having a first durometer; and, a second group of spicules having a second durometer different from said first durometer. In some embodiments said asperities have distal ends which deflect toward said axial direction of movement. In some embodiments said spicules are arranged along spaced-apart circular rows of equal numbers of spicules. In some embodiments a first of said circular rows comprises spicules non-uniformly spaced apart. In some embodiments, in each of said rows, spicules are circumferentially interposed in relations to spicules of adjacent rows.

In some embodiments said tip is mounted to said mounting structure in absence of an adhesive layer formed between said tip and said mounting structure.

In some embodiments said tip is mounted to said mounting structure through an adhesive layer formed between said tip and said mounting structure.

In some embodiments said tip and said mounting structure are made from co-moldable materials and wherein said tip is mounted to said mounting structure through a co-molded interface layer formed between said tip and said mounting structure.

In some embodiments said tool is adapted to provide a motion to the tip with respect to said handle, wherein said motion is selected from the group consisting of vibrational motion, reciprocating axial penetration motion, reciprocating turning motion, continuous single direction rotational motion, and combinations thereof.

In some embodiments there is provided a tool which further comprises: a tubular handle connecting said mounting structure; a source of pressurized irrigating fluid; and a flexible conduit connecting said source to said handle. In some embodiments said source comprises a pulsating pump. In some embodiments said tip has a coefficient of elasticity allowing expansion of said wall at peak pressure of said pump.

In some embodiments said cavity contains a fluid comprising a therapeutic agent.

In some embodiments said mounting structure further comprises a lumen for carrying a flow of a pressurized fluid. In some embodiments said lumen is in fluid communication with said cavity. In some embodiments said wall has a plurality of irrigating bores extending therethrough. In some embodiments said tip comprises a plurality of asperities joined integrally with, and projecting radially from said external surface wherein said bores are spaced a distance apart from said asperities. In some embodiments a first of said bores is oriented to direct a jet of said fluid upon one of said asperities. In some embodiments said fluid has a lubricity substantially similar to that of water. In some embodiments said fluid comprises a therapeutic agent. In some embodiments said mounting structure further comprises a plurality of fluid emitting spouts in fluid communication with said lumen.

In some embodiments said base comprises a first annulus of additional elastomeric material extending inwardly to form a ledge with said internal surface. In some embodiments said base further comprises a second annulus of additional elastomeric material, thereby forming a dual undercut mechanical interlock arrangement.

In some embodiments said tip has a height between approximately 1.0 cm (0.4 inch) and 1.5 cm (0.6 inch), a base radius between approximately 0.3 cm (0.12 inch) and 0.4 cm (0.16 inch) and a wall thickness between approximately 0.03 cm (0.012 inch) and 0.07 cm (0.28 inch).

In some embodiments each of said spicules has a height of approximately 3 millimeters (120 mils).

In some embodiments said tip has a limited collapsibility.

In some embodiments said mounting structure is releaseably fastened to a handle.

In some embodiments there is provided a tool which further comprises: means for powered rotation of said tip with respect to said handle.

In some embodiments there is provided a tool wherein said mounting structure is movably mounted to said handle; and a turbine mechanically linked to said mounting structure; said turbine being responsive to said flow of said pressurized fluid thereby causing said tip to rotate with respect to said handle. In some embodiments an amount of said fluid exhausted out of said turbine flows through a spout exiting said tool. In some embodiments said mounting structure is further mounted to said handle to allow movement selected from the group consisting of: vibrational movement; oscillating movement; reciprocating axial penetration movement; reciprocating rotational movement; single direction rotational movement; and, combinations thereof.

In some embodiments there is provided a dental hygiene tool which comprises: an inflatable tip having an outer surfaces and a wall defining an inner chamber; asperities extending from said outer surface; a source of fluid under pressure; means for modulating said pressure; a conduit connected at a first extremity to said source; a tubular handle having a distal end connected to said chamber and a proximal end connected to a second extremity of said conduit. In some embodiments said means for modulating comprises a pulsating pump. In some embodiments said tip has a conical shape and has a distal end dimensioned to penetrate interproximal spaces. In some embodiments said source of fluid comprises a therapeutic agent. In some embodiments said conical tip has a height between approximately 1.0 cm (0.4 inch) and 1.5 cm (0.6 inch), a base radius between approximately 0.3 cm (0.12 inch) and 0.4 cm (0.16 inch) and a wall thickness between approximately 0.03 cm (0.012 inch) and 0.07 cm (0.28 inch). In some embodiments each of said asperities has a height of approximately 3 millimeters (120 mils). In some embodiments the tool further comprises a plurality of asperities joined integrally with, and projecting radially from said external surface.

In some embodiments there is provided a dental hygiene tip sized and shaped to provide an effective durometer of between about 10 A and about 60 A on the ASTM durometer scale.

In some embodiments there is provided a dental hygiene tool which comprises: a tubular handle connecting a hollow mounting structure; a source of pressurized irrigating fluid; and a flexible conduit connecting said source to said handle; and, means for mounting a fluid emitting massager tip to a distal end of said handle.

In some embodiments there is provided a dental hygiene tool which comprises:a tubular handle connecting a hollow mounting structure; a source of pressurized irrigating fluid; said mounting structure being movably mounted to said handle; a turbine mechanically linked to said mounting structure; said turbine being responsive to said flow of said pressurized fluid thereby causing said structure to rotate with respect to said handle.

In some embodiments there is provided a dental hygiene tool tip which comprises: a flexible body having an external surface, a proximal base end and a distal end; a plurality of asperities joined integrally with, and projecting radially from said external surface, wherein said plurality of asperities having progressively diminishing sizes from said proximal base end to said distal end.

In some embodiments there is provided a dental hygiene tool tip which comprises: a flexible body having an external surface, a proximal base end and a distal end; a plurality of asperities joined integrally with, and projecting radially from said external surface, wherein said plurality of asperities having progressively different durometers from said proximal base end to said distal end.

In some embodiments there is provided that in a dental engagement tool having an end effector portion having elastomeric tip mounted upon a reinforcing member, an improvement wherein said reinforcing member is shaped and dimensioned to have an elongated dimension extending along an elongation axis and wherein said reinforcing member has a cross-section taken perpendicular to said axis, wherein said cross section has a first shape.

In some embodiments there is provided a kit of dental massager tips sized and shaped to penetrate the inter-proximal areas of a mammal wherein each of said massager tips has a mechanical compliance substantially different from others of said massager tips. In some embodiments a first of said massager tips has a first effective durometer and has first color; and a second of said massager tips has second effective durometer different from said first effective durometer, and a second color different from said first color.

### BRIEF DESCRIPTION OF THE DRAWINGS

FIG. 1 is a diagrammatical view of the dental hygiene tool according to an embodiment of the invention.

FIG. 2 is a perspective view thereof.

FIG. 3 is a distal end view thereof.

FIG. 4 is a cross-sectional view of the tip portion of the tool showing spicule locations and geometries.

FIG. 5 is a cross-sectional view of an alternate embodiment of the hollow tip portion loosely engaged by a reinforcing prong.

FIG. 6 is a cross-sectional view of the tip portion of the tool while in use.

FIG. 7 is a perspective view of an alternately shaped reinforcing prong.

FIG. 8 is a cross-sectional view of the prong of FIG. 6 taken at line 8-8.

FIG. 9 is a perspective view of an alternately shaped reinforcing prong having a ball apex.

FIG. 10 is a diagrammatical view of the dental hygiene tool according to an alternate embodiment of the invention connected to a pressurized fluid source.

FIG. 11 is a cross-sectional view of an alternate embodiment of the tool showing fluid ports in the distal region of the handle, a fluid lumen through the reinforcing prong.

FIG. 12 is a cross-sectional view of an alternate embodiment of the tip portion of the tool showing bore locations and geometries.

FIG. 13 is a cross-sectional view of an alternate embodiment of the tool showing an ambient fluid pumping and cleansing action.

FIG. 14 is a cross-sectional view of an alternate embodiment of the tool having a fluid turbine-driven rotating tip.

### DESCRIPTION OF THE PREFERRED EMBODIMENT(S)

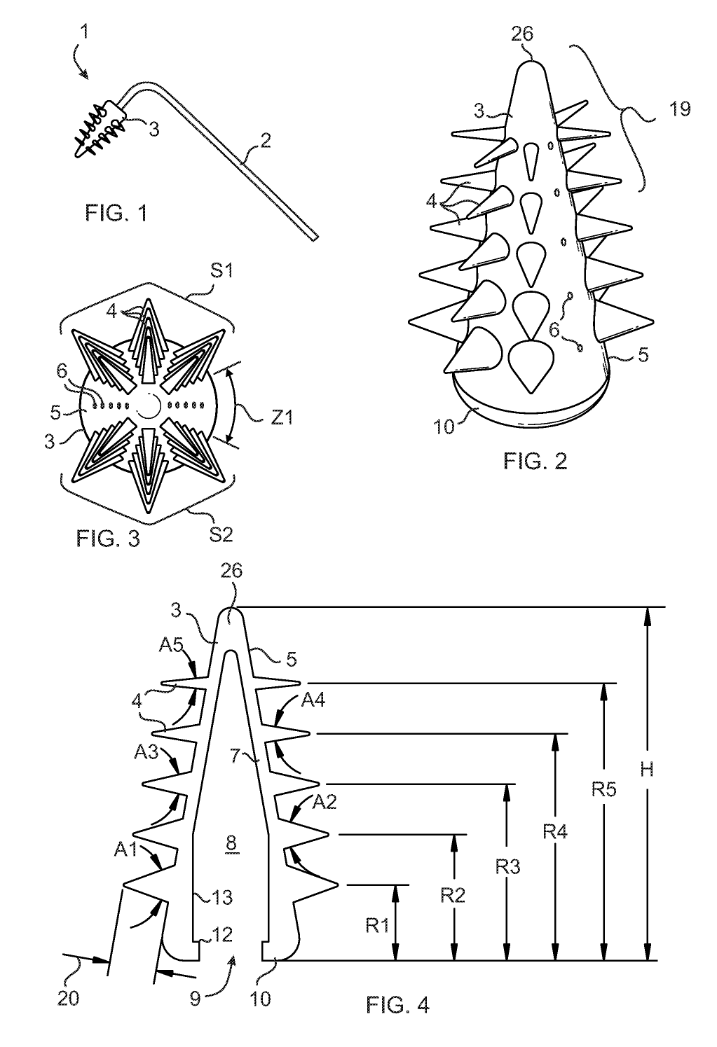

Referring now to the drawing, there is illustrated in FIG. 1 a dental hygiene tool 1, which includes a rigid handle 2, mounting at its distal end, a working tip 3. The dimension of the tip is small enough to allow its pointed upper apical part 19 to penetrate inter-proximal spaces, periodontal pockets, in between implants, surgical sites, around orthodontic appliances, under bridges, and other dental/implant restoration structures. In many applications therefore, the tip 3 can have an axial height H between approximately 1.0 cm (0.4 inch) and 1.5 cm (0.6 inch), a base radius between approximately 0.3 cm (0.12 inch) and 0.4 cm (0.16 inch) and a wall thickness between approximately 0.03 cm (0.012 inch) and 0.07 cm (0.28 inch).

The tip 3 is made from an elastomeric material such as silicon, urethane, rubber or other biocompatible resiliently compressible material having a durometer of less (i.e. more flexible) than about 80 A, more preferably less than about 60 A, and in most applications preferably less than about 35 A on the ASTM durometer scale. The flexibility of the outer surface of the tip helps allow the tool to contact structures such as dental implants made of titanium or ceramic coated restorations which are susceptible to scratching.

As shown in FIGS. 2-4, the tip 3 is preferably spiked with asperities in the form of conical spicules 4 which join integrally with and project gradually from the external surface 5 of the tip. Each spicule has a height 20 of approximately 3 mm (120 mils). Although conical spicules are preferred, spicules having other shapes can be used. Further, other types of asperities such as longitudinal or annular ribs, including those having undulations, can be used without departing from the invention. Small bores 6 are positioned between the spicules and extend through the wall 7 of the tip to allow passage of fluid in order to equalize pressure between the cavity and the ambient environment. The function of the bores will be described in greater detail below.

The spicules are arranged along spaced-apart circular rows of equal numbers of spicules. The spicules can be aligned axially. Alternately, within each row the spicules can be circumferentially interposed in relation to spicules of adjacent rows. In other words, the spicules can be actually lined up in every other space. The spicules of each row can be grouped into a pair of sets. A first set S1 has a first uniform angular spacing. The second set S2 has the same uniform angular spacing. The first set is angularly spaced apart from the second set to create an angular zone Z1 without a spicule. This allows the user to adjust the penetration profile of the tip by adjusting the angular or roll orientation of the tip.

As shown in FIG. 4, by way of example, spicules in a first proximal row R1 are located a first distance of about 3 millimeters from the base, in a second row R2, about 5 millimeters, in a third row R3, about 7 millimeters, in a fourth row R4, about 8 millimeters, and in a fifth R5, most distal row, about 10 millimeters. Alternately, the each row of spicules can be spaced apart in an equidistant manner.

The spicules have progressively diminishing sizes in terms of cross-sectional diameters from the base 10 to the apex 26 of the tip. In other words, the more distally located spicules have sharper conical shape than the more proximally located spicules. By way of example, spicules in a first proximal row can have a conical angle A1 of 40 degrees, in a second row A2, 33 degrees, in a third row A3, 26 degrees, in a fourth row A4, 19 degrees, and in a fifth, most distal row A5, 12 degrees. It is anticipated that the conical angle of the first proximal row can range between about 90 and about 30 degrees, the second row between about 60 and about 25 degrees, the third row between about 45 and about 20 degrees, the fourth row between about 35 and about 15 degrees, and the fifth distal row between about 30 and about 10 degrees.

As more specifically illustrated in FIGS. 4 & 5, the working tip 3 is a conical, hollow body defining an internal cavity 8. The tip 3 has a circular, axial aperture 9 in its base 10 proving an opening to the cavity 8. The aperture is shaped and sized to releasably mount the tip upon a mounting structure 11 formed on the distal end of the handle 2, thereby allowing the tip to be detachable and disposable. The beaded brim 17 of the mounting structure is retained by a ledge 12 formed by an annulus of additional material extending inwardly from the internal surface 13 of the tip. These structures are sized to provide secure but detachable friction fit in absence of any adhesive. Alternately, the tip may be bonded to the mounting structure using an adhesive or through co-molding as will be described later.

In an alternate embodiment, where a hermetic seal is formed between the tip and the mounting structure, and there are no bores formed through the tip wall, the cavity can be filled with a gas such as air. The pressure of that gas can be selected to achieve the desired effective durometer of the tip.

The mounting structure has a reinforcing member 15 formed by an oblong prong made of substantially rigid material such as stainless steel, titanium, aluminum, plastic, fiber-resin composite or other material having a flexural rigidity greater than that of the tip. The prong will therefore have a stiffness of at least 80 A durometer, and in most applications at least 75 D, where greater durometer means stiffer. In some embodiments, the reinforcing member can have some lesser flexural rigidity which will allow a degree of minor resilient bending. However, the reinforcing member should be rigid enough to act to guide the tip and not permanently deform under typical loads.

The reinforcing member 15 is shaped and dimensioned to penetrate the tip cavity 8 loosely and thereby form a gap 16 between the internal surfaces 13 of the tip 3 and the outer surfaces 21 of the reinforcing member which limits the range of collapse of the tip. In this way, the tip is allowed to collapse more readily while the gap is being reduced to provide a gentle massaging action, but is prevented from collapsing further when the gap is eliminated, thereby providing a compacting action. It is significant that the present embodiment is able to provide the dual functions of gentle massaging and compression in a single device. The presence of the rigid reinforcing member also prevents the apex 26 of the tip from wadding up thereby keeping the outer surfaces of the tip in place on the tissues of interest, rather than being pushed away. The member also acts to help precisely guide the apex into the areas of interest.

Accordingly, the tip resiliently and non-uniformly collapses from its at-rest, expanded state when subjected to external forces into a partial or even total collapsed state. The tip can also expand when these forces are reduced and/or removed. Those skilled in the art will note that portions of the tip may collapse when forces are applied to that portion while other portions remain expanded.

It shall be noted that both the tip material and the tip's shape and dimensioning will determine the overall compliance of the tip including its flexibility and the force of its resiliency. In other words, the physical parameters of the tip can be selected to provide the entire tip with a compliance which can be characterized as an effective durometer of between about 10 A and about 60 A on the ASTM durometer scale, and for most applications between about 10 A and about 30 A. The effective durometer is the measure of the tip's compliance until the tip is fully collapsed onto the reinforcing member whereupon its durometer would be essentially that of the tip material.

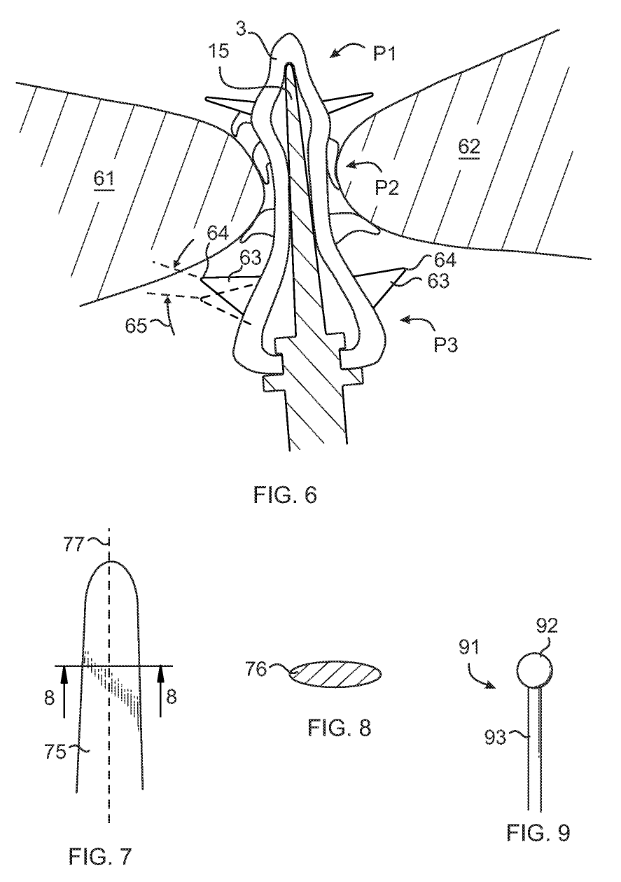

As shown in FIG. 6, by way of example, the presence of the reinforcing member 15 allows for more rapid, automatic expansion of the collapsed tip 3 due to its resiliency along portions of the tip where the forces causing collapse have been removed. In other words, the reinforcing member allows some portions P1,P3 of the tip to resiliently spring back and contact dental surfaces 61,62 during a single penetration or extraction motion while other portions P2 remain collapsed.

Further, as the central portion P2 of tip collapses, it beneficially causes the more proximal portion P3 to deflect distally. This in turn, causes the spicules 63 located on the proximal portion to deflect 65 their distal ends 64 toward the portion being collapsed. This automatically orients the distal ends toward the surfaces 61,62 being engaged, and thus encourages more prolonged contact of the spicule ends with those surfaces, thereby enhancing cleaning and massaging.

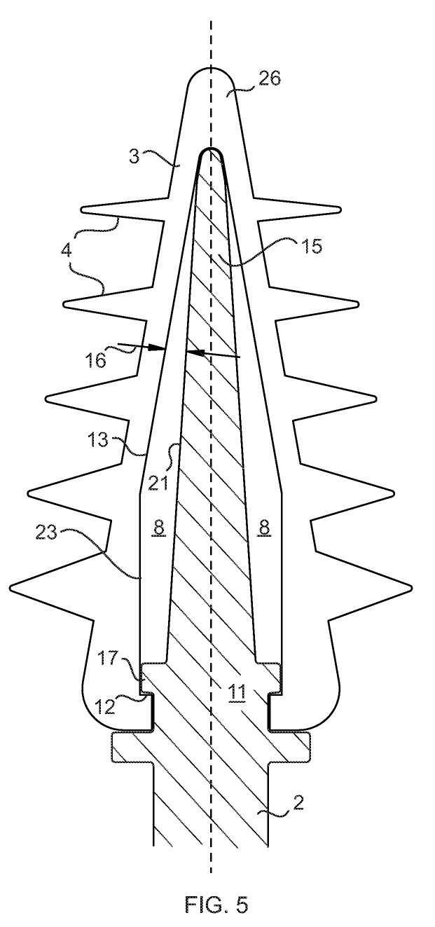

In the embodiment shown in FIG. 5, the shape of the cavity 8 and reinforcing prong 15 are both conical and selected so that the gap surrounds the reinforcing member and generally gets larger from the pointed distal end toward the base. Therefore the conical angle of the reinforcing member is smaller than that of the cavity. In the present embodiment the shape of a lower section 23 of the cavity is cylindrical so that the conical angle of the cavity can be made even greater, thus increasing the volume of the cavity. This allows for additional radial collapsibility of the tip so that the tool is less dependent on a particular orientation in space to massagingly engage unpredictably complexly shaped spaces in the dental areas. Therefore, the shape of the reinforcing member can be selected to be commensurate with the shape of the cavity. Further, the shape of the reinforcing member can be selected to be substantially angularly symmetric.

As shown in FIG. 7, alternately, the shape of the reinforcing member 75 can be selected to be non-angularly symmetric. In this case the reinforcing member has a substantially paddle shape having a generally elliptical cross-section 76 as shown in FIG. 8. This allows for a greater amount of collapse from one anglular direction than another. By rotating the tip around its longitudinal axis 77, the user can adjust collapsibility and flexural rigidity in a given direction in situ.

FIG. 9 provides an alternate reinforcing member prong 91 having a substantially cylindrical shaft portion 92 and a ball portion 93 at the distal end to help prevent puncture while minimizing the cross-section of the shaft portion, and thus help maximize the collapsibility of the tip.

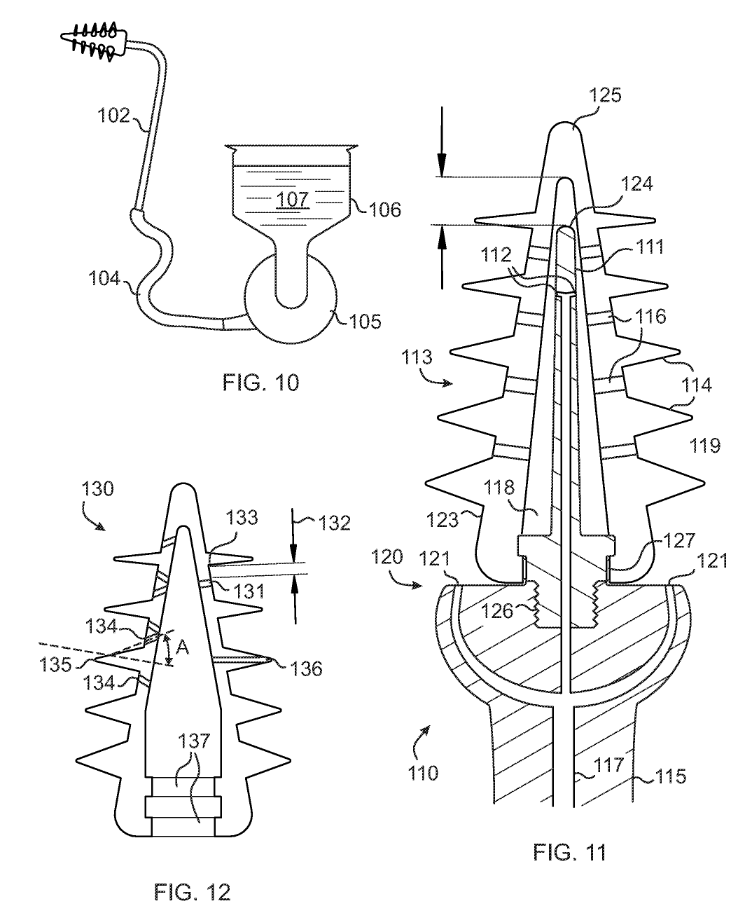

As shown in FIG. 10, the tool handle 102 can be further adapted to be tubular and have its proximal end connected to a flexible conduit 104. At its proximal extremity, the conduit is connected to a pulsating pump 105, fed by a reservoir 106 of fluid 107. The pulsating pump 105 is designed to emit successive small spurts of fluid at a frequency range between approximately 1-20 cycles per second. The fluid 107 in the reservoir 106 can be a gas but preferably a liquid such as water, saline, chlorhexidine, peroxide, various combined solutions and other biocompatible cleansing, irrigating and therapeutic fluid can be used. As a maximum, the fluid can be pressurized to between 2 and 5 psi. In this way the pressure of the supplied fluid can be used to adjust the resiliency and hence, collapsibility of the tip. In other words, increasing the pressure can cause the tip to more readily expand and resist the forces causing it to collapse when it is inflated with the pressurized fluid. The fluid preferably has a lubricity similar to that of water. The type and rate of fluid flow can further be selected to adjust the friction of the tip by changing its effective durometer by pressurization, and/or by coating the outer surfaces of the tip with a lubricating layer of fluid.

It can now be understood that under the pulsating pressure generated by the pump, the tip inflates and deflates in a vibrating motion which enhances the frictional actions of the spicules against dental surfaces, and can also provide a soothing, restorative massaging action against the gum tissues.

Alternately, the handle can be fitted with a mechanical vibration mechanism.

As shown in FIG. 11, there is an alternate embodiment of the tool 110 having a rigid reinforcing member 111 which has an internal fluid channel 111 leading to a pair of distal exit ports 112 emptying into the internal cavity 118 of the tip 113. The channel is connected at a proximal end to the fluid carrying lumen 117 of the handle 115. In this way a flow of pressurized fluid from the lumen 117 flows into the internal cavity 118. Bores 116 formed through the wall of the tip allow fluid to flow from within the cavity out onto the dental areas. In this embodiment, the bores are arranged in spaced-apart rings inter-spaced between the rows of spicules 114.

In this embodiment the lumen of the handle can alternately, or additionally, supply pressurized fluid to one or more spouts 121 formed on the distal end 120 of the handle 115. The spouts are oriented to direct a jet of irrigating fluid from the handle upon the external surface 123 of the tip 113. The embodiment further shows that there can be a separation between the distal extremity 124 of the reinforcing member 111 when the tip 113 is in its fully expanded state. This provides the distal end 125 of the tip to be more flexible during probing actions of the tool.

This embodiment also shows that the reinforcing members can be made to detach from the handle by threaded fastening 126, or other releaseable means. In this way, a number of differently sized reinforcing members having potentially different flexural rigidities can be supplied in the form of a kit in order to adapt the tool to different circumstances and uses.

In addition, a layer of adhesive 127 can be used to bond the tip to the mounting structure. Alternately, if a rigid plastic material is used for the mounting structure, it may be co-molded with the elastomeric tip during manufacture. In this way, the tip is bonded to the mounting structure along a co-mold interface layer (which can be indicated as well by the structure shown by reference character 127).

As shown in FIG. 12, there is an alternate embodiment of the tool tip 130 showing a bore 131 can be located a distance 132 spaced apart from the base of a spicule 133 in order to help ruggedize the spicules. In other words, locating a bore in close proximity to a spicule can reduce the life span of the tip due to wear and tear of the spicule connection to the tip body. Other bores 134 can be angled toward a spicule 135 at an angle A in order to form a jet of fluid that can wash debris from the spicule during use. A bore 136 can be located within a spicule so that irrigating fluid can be directed toward engaged tissues. This embodiment also provides the tip with a dual annulus structure 137 to provide a more rugged mechanical interface between the tip and mounting structure, which further helps seal the tip to the mounting structure in absence of any adhesive and avoid fluid leakage while still providing ready replaceability of the tip.

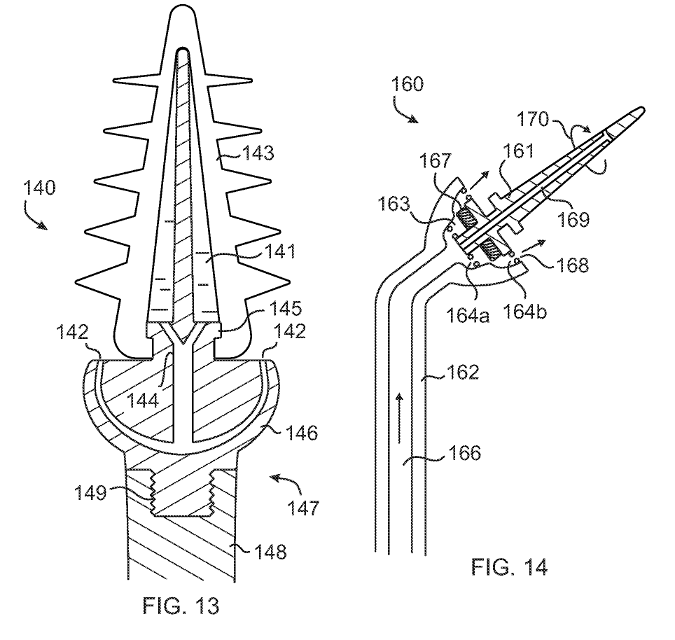

Referring now to FIG. 13, there is shown an alternate of the dental hygiene tool 140 having a non-powered, ambient fluid pressurization system. This embodiment is characterized by the resiliently collapsible tip 143 not having any fluid emitting bores. The tip initially collapses when first used, causing evacuation of the cavity. The cavity can be initially filled with air or some therapeutic solution 141. After initial collapse, the resiliency of the tip expanding causes a vacuum in the cavity which sucks ambient fluid into the spouts 142, through a manifold 144 and back into the cavity. The process is repeated with each collapse of the tip. This embodiment also show the mounting structure 145 can be integral with an endpiece 146 fastenable to a distal end 147 of the handle 148. The endpiece can be fastened by a threaded interface 149 or other releasable fastening means.

Referring now to FIG. 14, there is shown an alternate of the dental hygiene tool 160 adapted to provide for the automatic rotation 170 of the mounting structure 161 with respect to the handle 162. The mounting structure is rotatively mounted within a well 163 in the distal end of the handle by a pair of bearings 164a, 164b. Pressurized fluid is supplied to the well via an internal lumen 166 in the handle. The well is shaped and dimensioned to direct the flow of pressurized fluid through an impeller 167 formed onto the base of the mounting structure residing within the well. After flowing through the impeller, reduced pressure fluid exits the handle through spouts 168 extending from the well to the outer surface of the distal portion of the handle.

Optionally, the mounting structure can be formed to have an internal channel 169 for carrying pressurized fluid to the internal cavity of the tip as described earlier.

It should be noted that the pressure of the fluid can be adjusted to determine the torque on the tip. In this way the rotation of the tip can be set to stop when an obstruction to rotation of a given strength is encountered. Further the impeller can be adapted to cause additional movements such as reciprocating, bi-directional rotation, rotation in a single direction, axial oscillation movements, and combinations thereof.

In addition, the tip can be replaceable allowing for a kit of tips for providing less collapsibility, spicule rigidity, size, shape and other physical parameters so that as the patient heals, the tool can provide greater cleaning, deeper massaging, and/or greater comfort. The tips in the kit are selected according to the different healing stages common to most patients. By way of example, the following time periods and tip compliances are given. The first stage can be post-operation to about 2 weeks, and would have the lowest (most flexible) effective durometer at about 10 A. The next, intermediate stage would be from about 2 to about 6 weeks from surgery, and would use a tip having an intermediate effective durometer of about 30 A. The next, second intermediate healing stage would be begin about 6 weeks after surgery, and would provide a tip having an even stiffer effective durometer of about 50 A. Lastly, there is a toughening/maintenance stage where a tip having an effective durometer of about 65 A would be used.

The tips in the kit can be color coded according to the effective durometer to provide an easily discernable indication to the user of which type of tip is preferred at a given stage of recovery.

In addition, different purpose tips can be further identified by providing specific flavors. For example, a pink color coded tip could have a bubble gum flavor, yellow would be banana flavor, orange would be orange flavor, and green would have a lime flavor. The flavoring can be imbedded in the material of the tip or contained in solution in an fluid pre-loaded into the tip cavity.

While the preferred embodiments of the invention have been described, modifications can be made and other embodiments may be devised without departing from the spirit of the invention and the scope of the appended claims.

What is claimed is:

1. A dental hygiene tool which comprises:
a hollow and resiliently collapsible tip having an external surface and an internal surface defining an internal cavity;
a mounting structure associated with said tool;
said mounting structure comprising a substantially rigid reinforcing member; and,
said tip being mounted to said mounting structure; and said reinforcing member loosely engaging said cavity.

2. The tool of claim 1, wherein said tip comprises an elastomeric material and is dimensioned to penetrate interproximal spaces in an animal; and, wherein said tip comprises a base, a distal end and a wall therebetween.

3. The tool of claim 2, wherein said tip is sized and shaped to provide an effective durometer of between about 10 A and about 60 A on the ASTM durometer scale.

4. The tool of claim 3, which comprises a number of said tips each having a different effective durometer than the others of said tips.

5. The tool of claim 4, wherein each of said tips has a surface color corresponding to said effective durometer.

6. The tool of claim 1, wherein said reinforcing member is sized and shaped to provide a reducible gap between an outer surface of said reinforcing member and said internal surface of said tip.

7. The tool of claim 1, wherein said reinforcing member comprises a distal extremity in contact with said tip and thereby said reinforcing member acts as a guide for said tool.

8. The tool of claim 1, wherein said reinforcing member is sized and shaped to have an elongated dimension extending along an elongation axis and wherein said reinforcing member has a cross-section taken perpendicular to said axis, wherein said cross section has a first shape, wherein said first shape is selected from the group consisting of: circles, ellipses, triangles, quadrangles, polygons, shapes having concave portions, and shapes having parabolic portions.

9. The tool of claim 2, wherein said wall is substantially conical.

10. The tool of claim 1, wherein said tip comprises a plurality of asperities joined integrally with, and projecting radially from said external surface.

11. The tool of claim 10, wherein said asperities comprise a number of spicules having progressively diminishing sizes from said base to said distal end.

12. The tool of claim 10, wherein said asperities have distal ends which deflect toward said axial direction of movement.

13. The tool of claim 1, wherein said tip is mounted to said mounting structure in absence of an adhesive layer formed between said tip and said mounting structure.

14. The tool of claim 1, wherein said tip is mounted to said mounting structure through an adhesive layer formed between said tip and said mounting structure.

15. The tool of claim 1, wherein said tip and said mounting structure are made from co-moldable materials and wherein said tip is mounted to said mounting structure through a co-molded interface layer formed between said tip and said mounting structure.

16. The tool of claim 1, wherein said tool is adapted to provide a motion to the tip with respect to said handle, wherein said motion is selected from the group consisting of vibrational motion, reciprocating axial penetration motion, reciprocating turning motion, continuous single direction rotational motion, and combinations thereof.

17. The tool of claim 1, which further comprises:
a tubular handle connecting said mounting structure;
a source of pressurized irrigating fluid; and
a flexible conduit connecting said source to said handle.

18. The tool of claim 17, wherein said source comprises a pulsating pump.

19. The tool of claim 17, which further comprises:
wherein said tip has a coefficient of elasticity allowing expansion of said wall at peak pressure of said pump.

20. The tool of claim 1, wherein said mounting structure further comprises a lumen for carrying a flow of a pressurized fluid.

21. The tool of claim 20, wherein said lumen is in fluid communication with said cavity.

22. The tool of claim 2, wherein said wall has a plurality of irrigating bores extending therethrough.

23. The tool of claim 22, wherein a first of said bores is oriented to direct a jet of said fluid upon one of said asperities.

24. The tool of claim 20, wherein said fluid comprises a therapeutic agent.

25. The tool of claim 20, wherein said mounting structure further comprises a plurality of fluid emitting spouts in fluid communication with said lumen.

26. The tool of claim 2, wherein said tip has a height between approximately 1.0 cm (0.4 inch) and 1.5 cm (0.6 inch), a base radius between approximately 0.3 cm (0.12 inch) and 0.4 cm (0.16 inch) and a wall thickness between approximately 0.03 cm (0.012 inch) and 0.07 cm (0.28 inch).

27. The tool of claim 1, wherein said mounting structure is releaseably fastened to a handle.

28. The tool of claim 16, which further comprises:
said mounting structure being movably mounted to said handle;
a turbine mechanically linked to said mounting structure; said turbine being responsive to said flow of said pressurized fluid thereby causing said tip to rotate with respect to said handle.

29. The tool of claim 16, wherein said mounting structure is further mounted to said handle to allow movement selected from the group consisting of: vibrational movement; oscillating movement; reciprocating axial penetration movement; reciprocating rotational movement; single direction rotational movement; and, combinations thereof.

30. A dental hygiene tool which comprises:
an inflatable tip having an outer surfaces and a wall defining an inner chamber;
asperities extending from said outer surface;
a source of fluid under pressure;
means for modulating said pressure;
a conduit connected at a first extremity to said source;
a tubular handle having a distal end connected to said chamber and a proximal end connected to a second extremity of said conduit.

31. A dental hygiene tip sized and shaped to provide an effective durometer of between about 10 A and about 60 A on the ASTM durometer scale.

32. A dental hygiene tool tip which comprises:
a flexible body having an external surface, a proximal base end and a distal end;
a plurality of asperities joined integrally with, and projecting radially from said external surface, wherein said plurality of asperities having progressively diminishing sizes from said proximal base end to said distal end.
